(19) United States
(12) Patent Application Publication
(10) Pub. No.: US 2008/0078429 A1
(43) Pub. Date: Apr. 3, 2008

(54) Cleaning device for paint rollers

(76) Inventor: Terry A. Hoffmann, Wildwood, MO (US)

Correspondence Address: Paul M. Denk, 763 S. New Ballas Rd, S. 170, St. Louis, MO, 63141, US

(21) Appl. No.: 11/904,562

(22) Filed: Sep. 27, 2007

Related U.S. Application Data
(60) Provisional application No. 60/847,879, filed on Sep. 28, 2006.

(51) Int. Cl. B08B 3/02; B08B 13/00

(52) U.S. Cl. 134/178

(57) ABSTRACT

Paint rollers may be cleaned of water soluble paints within this apparatus which is comprised of an enclosed housing with a drain at the bottom which also contains an oscillating water manifold the length of the roller which produces a series of water jets aligned with the elongated axis of the housing which impact the paint roller starting at a tangent to the roller so as to impart a spin. The water manifold oscillates aligned with the elongated axis of the roller from the tangent to a center of roller that slows the spin of the roller which oscillates to the opposite tangent of the roller and which spins the roller in the opposite direction. The enclosed housing also contains a single jet of water aligned near the top of the roller and at a tangent to the roller which impacts the paint roller starting at a tangent to the roller so as to impart a spin. The single water jet and the oscillating water jets are connected to a three-way valve which sends water to either the oscillating water manifold, the single water jet or shuts off the flow of water entirely. An opening with a hinged lid at the top of the enclosed housing allows the insertion of the paint roller. A clamping means is located on the outside of the housing on the side opposite the location of the oscillating water manifold and single fixed water jet which adapts to a variety of paint roller holder rods in order that the paint roller itself may be properly align the roller parallel to the oscillating water manifold within the housing. The water jets on the oscillating water manifold impact off-center on the pile of the paint roller, washing out the water soluble paint, and imparting a spin on the roller which throws out the diluted paint and the wash water. As the water manifold oscillates to the center of the paint roller, the rotation of the paint roller decreases and forces water deep into the pile of the paint roller that will dilute the paint. As the oscillating water manifold passes the center of the roller, the roller starts to spin in the opposite direction imparting a spin on the roller that throws out the diluted paint and wash water from deep within the pile of the paint roller.

### CROSS REFERENCE TO RELATED APPLICATION

This non-provisional application claims priority to provisional application Ser. No. 60/847,879 filed on Sep. 28, 2006.

### BACKGROUND OF THE INVENTION

This invention relates to a device useful for cleaning wet water soluble paint from a paint roller. This invention eliminates the messy operation of cleaning a paint roller of water soluble paint after its usage, which normally scatters cleaning water filled with paint residue extensively, during a cleaning operation.

Since the cost of a paint roller varies between $2.00-$12.00, in the retail market, the idea of being able to effectively clean and reuse a high quality roller is desirable. The average price of a reusable roller is normally within the range of $8.00. Thus, the application of a cleaning device to keep a roller relatively free of residue paint, after its usage, is desirable.

After reviewing the products in the market, it appears that the only manufactured product to wash a paint roller was sold by Sears Roebuck & Company. It consisted of a small round plastic ring with water jets directed towards the center of the ring, and a hose would attach to a faucet to supply water to the jets. The water jet ring would be manually raised and lowered over the length of the paint roller, to achieve its cleaning. After considerable usage, for a length of time, eventually the paint would be washed out. Currently, it does not appear that this product is any longer upon the market. Furthermore, the process of its usage was manual and messy.

Other investigations have not found any related or known device for use for washing water soluble paint manually or automatically from a paint roller. Usage of any type of an apparatus to clean oil based paint from a paint roller is just not economical. It would require the usage of too much paint thinner to remove all the paint from the nap of the roller.

There are other embodiments in the prior art that disclose various means for operating as cleaning apparatuses, even for the paint roller. For example, the patent to Krueger, U.S. Pat. No. 3,886,960, shows a paint roller cleaning apparatus. The paint roller is installed within its casing, as along an integral slot, and comes to rest upon its lower surface. A garden hose connects with a pipe, that incorporates a series of jets, which are directed tangentially against the side of the paint soiled roller, in order to affect its washing and cleaning.

The patent to Wright, et al, U.S. Pat. No. 3,897,797, is upon an applicator roller cleaner having adjustable spray header. This particular cleaner also includes its tubular housing, that fits upon a base, incorporates a lid, having a central opening therethrough, and through which the paint roller may be rested, during cleaning. The lid also includes an opening for insertion of the spray tube, which has a source of water connected to it, as noted. Its maximum cleaning and rinsing action can be achieved when the water spray impinges only slightly to one side of the centerline of the emplaced roller. The patent then states that the roller can be spun dry, after washing.

The patent to Conley, et al, U.S. Pat. No. 4,641,673, shows another cleaning device for paint rollers and brushes. This particular device also includes a housing enclosure, having a water manifold located therein, incorporating a plurality of orifices, as noted. The water jets are directed towards a supported paint roller, and the paint roller is held in position by means of clamping means, as can be seen. The waters directed from the manifold angulated towards the side of the paint roller, in order to provide for its rotation. The device may also be used for holding a paint brush for cleansing, as noted. Furthermore, multiple jets of water may be used. The bottom of this housing appears to be opened, apparently staked by means of legs to the ground. Thus, apparently, the cleansing water and removed paint will simply flow under the ground, as can be understood.

The patent to Brandt, U.S. Pat. No. 4,672,987, shows a device for cleaning paint rollers. This device also includes the cleaner, having its paint roller located therein, held in place by means of the particularly designed cover. Then, a spray tube, which connects with the flexible garden hose, supplies water to the water jet openings, which are also directed at an angle, as noted. This provides for rotation and cleansing of the roller during its cleaning operation.

The patent to Patterson, U.S. Pat. No. 4,700,728, shows a further device for cleaning paint rollers. This device constructed similarly to those as previously defined. But, it has its own specific structure, so as to differentiate it from the prior art. You can see there is the usual housing, having the spray means for directing a cleaning fluid towards the roll, when in place. The housing has formed with it a plate, which connects with a series of connecting plates, held into position by means of fasteners, to hold the angulated arm of the roller in place, during a cleaning operation.

The patent to Shipman, U.S. Pat. No. 4,832,066, shows a hydro centrifugal paint roller paint cleaning aid. The structure of this device, is very specific, it includes its cylindrically shaped wall housing, and it has two elongated spray tubes, it has a funnel provided at the lower end of the housing, and it also has a different style of support cradle, incorporating straps, for holding the roller handle in place. This is done as the roller itself extends into and through the shown slot, during a cleansing operation.

The patent to Phipps, U.S. Pat. No. 5,095,928, shows another paint roller cleaning device. This device is constructed a little differently, with its spray shield incorporating a water manifold or liquid spray jets, that supplies fluid from the connector. The invention, though, is really the integral structure having the pair of handle slots, so that the handle of the roller can be oriented at different angles, to provide for apparently that tangential spray of fluid to the sides of the roller to provide it for cleaning. It also has wedge shaped shaft slots that are set forth as noted, and which define various slots for holding the roller shaft at various angles through the wedge shaped configuration of the device.

The patent to Howe, U.S. Pat. No. 5,357,769, discloses another paint roller cover cleaning device. This device apparently sticks a garden hose, with its nozzle, through the flexible plastic or rubber flap, and therein sprays water against a roller, to achieve some degree of cleansing.

The patent to McDowell, U.S. Pat. No. 5,363,869, shows another paint roller cleaning assembly. This particular device utilizes an enclosure that has an open bottom, as a garden hose connection to the two risers, which are really the manifolds. The roller extends down through the opening, its handle is held by the insert, during the washing action.

The patent to Glunt, U.S. Pat. No. 5,409,027, discloses an apparatus for cleaning paint rollers through plural sprays which turn and clean supported rollers. This particular device claims an apparatus for cleaning paint rollers, and includes its central manifold, that sprays water internally of the roller, while the external manifold sprays the outside of the roller.

The patent to Gorecki, U.S. Pat. No. 5,505,220, shows a dual tangential spray paint roller cleaner. This particular device, as its title implies, includes a first and second water spray bar, arrange externally of its specific structure of the device, as can be noted. It defines the use of a handle attached to the exterior side wall of the containment vessel to facilitate its portability.

Also known in the prior art is the oscillating type of lawn sprinkler, that presents a spray of water to the lawn, oscillating over a angular relationship, while delivering a patterned spray of water to a lawn, as known.

Finally, the patent to Bisby, U.S. Pat. No. 5,839,459, defines a paint roller cleaning apparatus. This particular device is apparently designed for clamping on to a phosit hydrant and is similar in structure to related devices that obtain water from a hose or other source.

### SUMMARY OF THE INVENTION

Purpose: The purpose of this invention is to completely, cleanly and automatically wash water soluble paint from a paint roller including from deep within the nap of the roller and semi-automatically spin dry the roller.

Cleaning Solution and Operating Force: The device will be operated using water as the operating force. The device should be non-electrical in order to eliminate possibility of electrical shock and need for an Underwriters Laboratory (U.L.) label. A supply of water is accessible and convenient. It also provided with sufficient pressure to operate the device. The cleaning solution for water soluble paints is obviously water. Under sufficient pressure, soap would not be necessary to properly clean a paint roller.

Physics of Operation: The operation of the device will use water and centrifugal force to remove paint and water from the paint roller. The device operates in two modes:
1. washing mode; and
2. dry mode.

### It should be automatic for the removal of paint and semi-automatic for drying the roller.

Materials: As much of the device should be manufactured from plastic and aluminum to eliminate possibility of rust and corrosion. It is, therefore, the principle object of this invention to provide a cleaning device for paint rollers, and which is very affective in cleaning paint deep from within the nap of a roller and then semi-automatically spin dry the same after cleansing.

Another object of this invention is to provide a washing means within a paint roller cleaner that is oscillatory of action, so that it will not only provide for directing water upon various aspects of the arcuate surface of the paint roller, but at the same time, tends to attain its rotation, to achieve complete washing.

Another object of this invention is to provide for directing of washing water upon a paint roller from an oscillating movement, at the time, and thereafter, achieve some degree of rinsing and some drying by directing a re-orientated jet of water tangentially along the surface of the roller.

Still another object of this invention is to provide a paint roller cleaning device that utilizes an oscillating set of water jets.

Still another object of this invention is to provide a cleaning device for a paint roller where the plurality of water jets directed towards the roller can be angulated, so as to direct water either downwardly onto the roller, and at the same time simultaneously upwardly on the roller, during cleansing.

Yet another object of this invention is to provide for a single jet of water, after the roller has been thoroughly washed, which is directed tangentially to the paint roller and spins the roller reasonably dry of excess water and dissolved paint.

Yet another object of this invention is to provide a paint roller cleaning device where the water flow is controlled by a three-way valve; and

Still another object of this invention is to provide for the hinged or otherwise connection of a lid onto the paint roller casing.

These and other objects may become more apparent to those skilled in the art upon review of this summary of the invention as provided herein, and upon undertaking a study of the description.

### BRIEF DESCRIPTION OF THE DRAWINGS

Other objects, features and advantages of this invention will be apparent from a study of the written description and the drawings in which:

FIG. 1 is an isometric view of the paint roller cleaning apparatus.

FIG. 2 is a sectional view of the apparatus in accordance with FIG. 1 taken along line 2-2.

FIG. 3 is a top plan view of the apparatus in accordance with FIG. 1.

FIG. 4 is a sectional view in accordance with FIG. 3 taken along line 4-4.

FIG. 5 is a sectional view in accordance with FIG. 2 taken along line 5-5.

FIG. 6 is a sectional view in accordance with FIG. 2 taken along line 6-6.

FIG. 7 is a sectional plan view in accordance with FIG. 2 taken along line 7-7.

FIG. 8 is a sectional plan view in accordance with FIG. 2 taken along line 8-8.

FIG. 9 is a sectional view in accordance with FIG. 2 taken along line 9-9.

FIG. 10 is a side elevation in accordance with FIG. 1.

FIG. 11 is an enlarged view in accordance with FIG. 9 taken as detail FIG. 11.

### DESCRIPTION OF THE PREFERRED EMBODIMENT

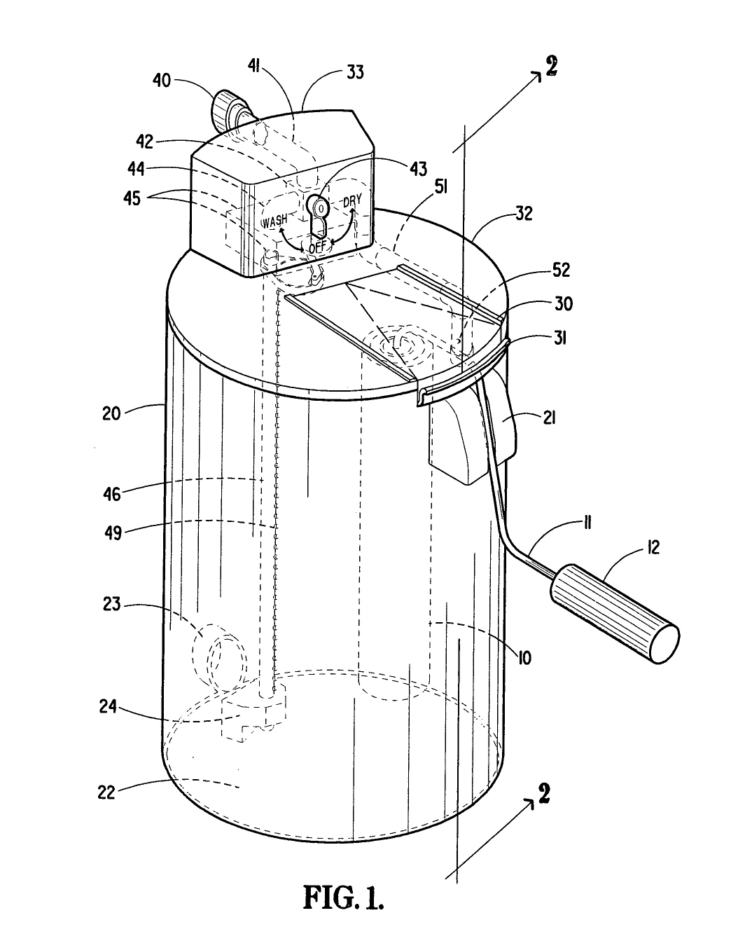

Referring now to isometric view FIG. 1, a paint roller cleaner in accordance with my invention is illustrated showing a paint roller 10 attached to a roller handle 11 and a handle grip 12 inserted into the apparatus. The apparatus consists of an upper cover 32 attached to a lower casing 20.

The upper cover 32 consists of a hinged lid 30 which is large enough to receive the paint roller 10 and paint roller handle 11 with a snap lip latch 31 that locks down the lid to the lower casing 20 and also secures the paint roller handle 11 in a grooved bracket 21. Integral to the upper cover is the operating mechanism housing 33 imprinted with WASH-OFF-DRY around the three-way valve lever 43. On the back of the housing 33 is a water coupling connector 40 that connects to the water supply tubing 41. The water supply tubing connects to a three-way valve 42 that is controlled by a lever 43. The three-way valve performs three functions. The first function is to shut off the flow of water to the apparatus. The second function is to divert water to the oscillating operating mechanism 45 through a supply tube 44. The third function of the three-way valve is to divert water to the spin drying jet 52 through a supply tube 51.

The lower casing 20 is a drum shape container that consists of a bottom 22, a drain 23 on the back at the bottom of the casing 20 with a support 24 in the bottom of the lower casing to support the oscillating sprayer tube 45. The lower casing has a grooved bracket 21 that is on the inside and the outside of the lower casing that aligns with the upper cover hinged lid 30 to support the paint roller handle 11.

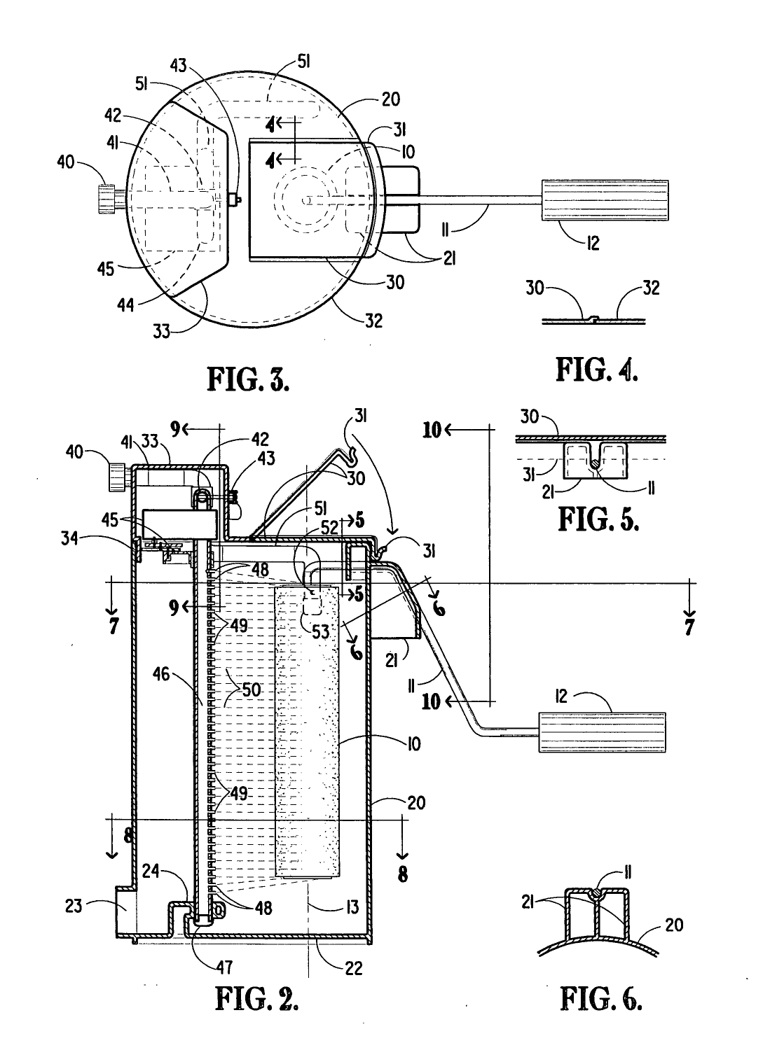

FIG. 2 is a sectional view cut vertically through the center of the apparatus taken along line 2-2 in FIG. 1 showing the upper cover assembly 32 and the lower casing assembly 20 along with the oscillating sprayer washer assembly 45 through 49, the fixed dryer jet assembly 51 through 53, and the position of the paint roller 10, paint roller handle 11 and the handle grip 12 along a centerline 13. The upper cover assembly 32 shows the hinged lid 30 with the snap lip latch 31 in the partially opened and closed positions and the operating mechanism housing 33. The water supply assembly consists of a water connecting coupler 40, water supply tubing 41, three-way valve 42 with control lever 43. The oscillating sprayer washing assembly consists of water supply tube 44 running from the three-way valve 42 to the water driven oscillating mechanism 45. Connected to the oscillating mechanism is a vertical spray tube 46 closed at the bottom with a plug 47 and set loose in the support 24 in the bottom of the lower casing assembly 20 in order to allow the sprayer tube 46 to oscillate freely. Along one side of the spray tube 46 is a series of water jets 48 and 49. There are two water jets 48 at the top and two water jets 48 at the bottom of the spray tube 46. These four water jets direct streams of water at an angle to the centerline 13 down towards the top and up towards the bottom of the paint roller 10 in order to clean the ends of the roller. The vertical row of water jets 49 direct streams of water 50 perpendicular to the centerline 13 in order to clean the face of the paint roller 10. The fixed dryer jet assembly consists of a water supply tube 51 running from the three-way valve 42 to the single dryer water jet 52. The dryer jet is located at the top of the paint roller 10 and directs a stream of water tangent to the paint roller 10 along centerline 13. The end of the fixed dryer jet assembly is closed with a cap 53.

FIG. 3 is a top plan view of the apparatus showing the upper cover assembly 32 including the hinged lid 30 with the snap lip latch 31, the operating mechanism housing 33 with the water supply tubing 41, three-way valve 42, three-way valve lever 43, the water supply tubing 44 to the oscillating mechanism 45 and the water supply tubing 51 to the fixed dryer jet assembly. FIG. 3 also shows the position of the paint roller 10, paint roller handle 11 and the handle grip 12.

FIG. 4 is a sectional view along line 4-4 in FIG. 3 showing the upper cover assembly 32 and the overlapping hinged lid 30.

FIG. 5 is a sectional view along line 5-5 in FIG. 2 showing an elevation of the interior portion of the grooved bracket 21 and how the snap lip latch 31 locks the paint roller handle 11 in place.

FIG. 6 is a sectional view along line 6-6 in FIG. 2 showing the exterior portion the grooved bracket 21 and its connection to the lower casing 20.

FIG. 7 is a sectional plan view along lining 7-7 in FIG. 2 towards the top of the apparatus showing the oscillating vertical spray tube 46 with water jets 49 and the position of the paint roller 10, paint roller handle 11 and the handle grip 12 all locked into the grooved bracket 21 on the side of the lower housing 20. The water jets 49 direct streams of water tangentially from one side 50a of the other of the paint roller 10 to the other side 50c. When the three-way valve lever is turned to WASH, the jet streams oscillate to position 50a, the paint roller 10 begins to spin clockwise removing the diluted water soluble paint and excess water. As the jet streams oscillate to position 50b, the paint roller 10 slows then stops. This forces large amounts of water deep into the nap of the paint roller 10 diluting the water soluble paint. As the jet streams oscillate to position 50c, the paint roller 10 reserves rotation and begins to spin counter clockwise removing the diluted water soluble paint and excess water. After sufficient oscillations to remove all paint, determined by clean and clear water running out of the drain, the three-way valve lever is turned to DRY. Under more water pressure than the multiple washing jets 49, the single drying jet 52 directs a stream of water at the top and tangentially to one side of the paint roller 10 rotating the paint roller 10 clockwise at a high rate of spin. The centrifugal force exerted by the high rate of spin removes all excess water from the paint roller 10. After the excess water is removed, the three-way valve lever is turned to the OFF position. The drying jet is located towards the top of the paint roller 10 in order to accommodate all lengths of roller.

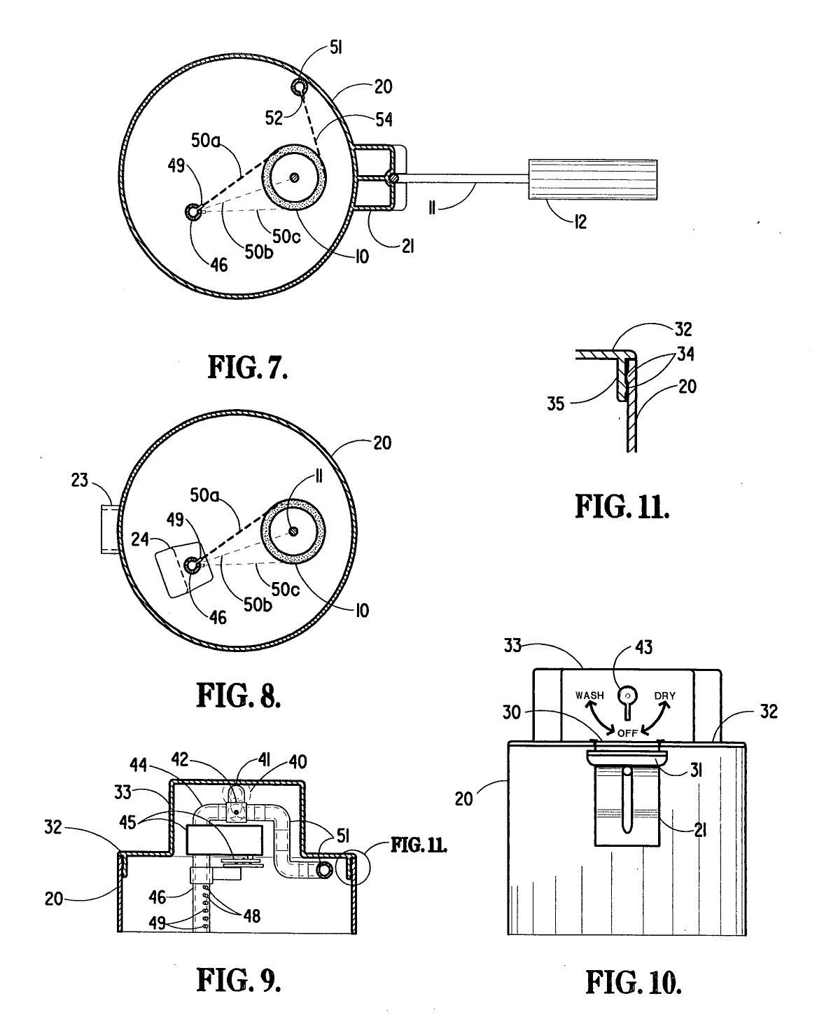

FIG. 8 is a sectional plan view along line 8-8 in FIG. 2 towards the bottom of the apparatus again showing the oscillating vertical spray tube 46 set in the support 24 with water jets 49 and the position of the paint roller 10, paint roller handle 11. The operation of the water jets 49 and their oscillating directions 50a, 50b, and 50c are identical to that in FIG. 7. This figure also shows the drain 23 on the back of the lower housing 20.

FIG. 9 is a vertical section view along line 9-9 in FIG. 2 showing the operating mechanism housing 33, upper cover 32 and lower casing 20. This figure also shows the water supply coupling connector 40 connected to the water supply tubing 41 connected to a three-way valve 42. The water supply tubing 44 connects to the three-way valve to the water driven oscillating mechanism 45 which oscillates the vertical water spray tube 46 containing the water jets 48 and 49. The water supply tubing 51 connects the three-way valve to the fixed dryer jet assembly.

FIG. 10 is the partial front elevation at the top of the apparatus along line 10-10 in FIG. 2 showing the upper cover assembly 32, with the hinged lid 30 and snap lip latch 31. This view shows the WASH-OFF-DRY imprinted on the operating mechanism housing 33 with the three-way valve lever 43. This view is shown without the paint roller handle 11 and handle grip 12.

FIG. 11 is a detail view taken from FIG. 9 showing the upper cover assembly 32 locking into the lower casing 20. An integral ridge 34 on the outside of a vertical leg 35 around the perimeter of the upper cover 32 locks into the integral ridge 34 on the inside and at the top of the lower casing 20.

It should be noted that my invention is adapted to clean any size and type of standard paint roller without any changes or adjustments to the apparatus. This invention is self-cleaning and requires no power other than that derived from the pressure obtained from standard household water supply pressure. The spinning of the roller by the oscillating water jets assists in the loosening of paint particles from the roller during the washing cycle. The single water jet assists in the centrifugal drying of the paint roller while adding no additional water to the roller.

This invention has been described with reference to the presently preferred embodiments that are illustrated in the drawings. It is not intended that the specific illustration of such preferred embodiments be construed as unduly limiting of the invention which is intended to be defined by the means and steps, and their obvious equivalents, set forth in the following claims.

I claim:

1. A cleaning device for paint rollers, comprising:
a. an upright cylindrical housing having a hinged lid at its top for locating of a paint roller within said housing, said cylindrical housing being enclosed at its bottom, a side opening provided proximate the bottom for allowing waste water and solublized paint to be drained from the housing at least after usage;
b. a grooved channel provided both interiorly and exteriorly of the housing at its approximate top, to receive a portion of the paint roller handle and to affix the paint roller in position during a cleaning operation;
c. said hinged lid providing for an opening through which the paint roller may be applied within the housing in preparation for a cleaning operation;
d. a multi-way valve provided proximate the cylindrical housing to provide for control of the water being applied to the housing during a cleaning operation; and
e. an oscillating sprayer washing assembly including a spray tube attached to the top of the housing and supported at the bottom of the housing for directing oscillating streams of water against the roller during a washing operation, said washing assembly connected to the three-way valve to provide for regulation and control of the operations of the washing assembly during application.

2. The cleaning device of claim 1 wherein said spray tube having at least one angled jet provided at the top and the bottom of the spray tube to direct washing water towards the top and the bottom of any paint roller, and there being a series of horizontal jets provided along the spray tube between the angled jets for directing water towards the paint roller during a washing operation.

3. The cleaning device of claim 1 and including a water jet dryer assembly connected to the three-way valve and providing a single jet of water directed towards the top of any roller located within the cleaning device and directed tangentially to the roller to provide for its spin dry after a washing operation.

4. The cleaning device of claim 1 wherein the oscillating set of water jets spraying tangentially to any paint roller located within its housing during a washing operation to achieve a rotation of the paint roller during its washing.

5. The paint roller cleaning device of claim 4 wherein the oscillating set of water jets includes two top jets angled down towards the top of any paint roller, and with two bottom jets angled upwardly towards the bottom of any housing located paint roller being cleaned.

6. The cleaning device of claim 1 in which a single water jet is directed tangentially to the paint roller to rapidly spin the roller in an effort to centrifugally remove any excess water and dissolve the paint from the roller after a washing operation

7. The paint roller cleaning device on claim 1 in which the direction and pressure of the water flow is controlled by said multi-way valve.

8. The paint roller cleaning device of claim 7 wherein said valve is a three-way valve.

9. The paint roller cleaning device of claim 1 in which the paint roller handle is locked into position by closure of the hinged lid upon the cylindrical housing.

10. The paint roller cleaning device of claim 8 wherein said hinge lid includes a snap latch to secure the lid and paint roller in a fixed and housing enclosed position.

11. The paint roller cleaning device of claim 1 in which the cleaning fluid is water.
